(19) United States
(12) Patent Application Publication
(10) Pub. No.: US 2024/0087142 A1
(43) Pub. Date: Mar. 14, 2024

(54) MOTION TRACKING OF A TOOTHCARE APPLIANCE

(71) Applicant: Conopco, Inc., d/b/a UNILEVER, Englewood Cliffs, NJ (US)

(72) Inventors: Timur ALMAEV, Nottingham (GB); Anthony BROWN, Nottingham (GB); William Westwood PRESTON, Nottingham (GB); Robert Lindsay TRELOAR, Hoole (GB); Michel François VALSTAR, Nottingham (GB); Ruediger Zillmer, Bebington (GB)

(73) Assignee: Conopco, Inc., d/b/a UNILEVER, Englewood Cliffs, NJ (US)

(21) Appl. No.: 17/914,444

(22) PCT Filed: Mar. 12, 2021
(86) PCT No.: PCT/EP2021/056283

§ 371 Date: Sep. 26, 2022

(30) Foreign Application Priority Data
Mar. 31, 2020 (EP) 20167083.3

(51) Int. Cl. G06T 7/246; A46B 15/00; G06T 7/73; G06V 10/56; G06V 20/40; G06V 40/16; G06V 40/20

(52) U.S. Cl. CPC G06T 7/248; A46B 15/0006; G06T 7/74; G06V 10/56; G06V 20/41; G06V 20/46; G06V 40/165; G06V 40/171; G06V 40/20; A46B 2200/1066; G06T 2207/10016; G06T 2207/10024; G06T 2207/30036; G06T 2207/30201; G06T 2207/30204

(57) ABSTRACT

A method of tracking a user's toothcare activity comprises receiving video images of a user's face during, e.g. a toothbrushing session, and identifying, in each of a plurality of frames of the video images, predetermined features of the user's face. The features include at least two invariant landmarks associated with the user's face and one or more landmarks selected from at least mouth feature positions and eye feature positions. Predetermined marker features of a toothcare appliance, e.g. a brush in use are identified in each of the plurality of frames of the video images. From the at least two invariant landmarks associated with the user's nose, a measure of inter-landmark distance is determined. An appliance length normalised by the inter-landmark distance is determined. From the one or more landmarks selected from at least mouth feature positions and eye feature positions, one or more appliance-to-facial feature distances each normalised by the inter-landmark distance is determined. A appliance-to-nose angle and one or more appliance-to-facial feature angles is determined. Using the determined angles, the normalised appliance length and the normalised appliance-to-facial feature distances, each frame is classified as corresponding to one of a plurality of possible tooth regions being brushed.

### FIELD OF INVENTION

This disclosure relates to tracking the motion of oral hygiene devices or appliances, such as electric or manual toothbrushes, during an oral hygiene routine generally referred to herein as a toothcare or tooth brushing routine.

### BACKGROUND & PRIOR ART

The effectiveness of a person's toothbrushing routine can vary considerably according to a number of factors including the duration of toothbrushing in each part of the mouth, the total duration of toothbrushing, the extent to which each surface of individual teeth and all regions of the mouth are brushed, and the angles and directions of brush strokes made. A number of systems have been developed for tracking the motion of a toothbrush in a user's mouth in order to provide feedback on brushing technique and to assist the user in achieving an optimum toothbrushing routine.

Some of these toothbrush tracking systems have the disadvantage of requiring motion sensors such as accelerometers built into the toothbrush. Such motion sensors can be expensive to add to an otherwise low-cost and relatively disposable item such as a toothbrush and can also require associated signal transmission hardware and software to pass data from sensors on or in the toothbrush to a suitable processing device and display device.

An additional problem arises because the pose of a person's head while toothbrushing affects the contact position of the mouth region with respect to an established brush position. Some toothbrush tracking systems also attempt to track movement of the user's head in order to better determine regions of the mouth that may be being brushed, but this can also be a complex task using some form of three-dimensional imaging system to track position and orientation of the user's head.

US2020359777 AA (Dentlytec GPL Ltd) discloses a dental device tracking method including acquiring, using an imager of a dental device, at least a first image which includes an image of at least one user body portion outside of a user's oral cavity; identifying the at least one user body portion in the first image; and determining, using the at least the first image, a position of the dental device with respect to the at least one user body portion.

CN110495962 A (HI P Shanghai Domestic Appliance Company, 2019) discloses intelligent toothbrushes to be used in a method for monitoring the position of a toothbrush. An image including the human face and the toothbrush are obtained and used for detecting the position of the human face and establishing a human face coordinate system. The image including the human face and the toothbrush is used for detecting the position of the toothbrush. The position of the toothbrush in the human face coordinate system is analyzed and first classification areas where the toothbrush is located are judged; and posture data of the toothbrush are obtained and second classification areas where the toothbrush is located are judged. Based on the image including the human face and the image including the face and the toothbrush, the first classification areas where the toothbrush is located are obtained; and through a multi-axis sensor and a classifier, the second classification areas where the toothbrush is located are obtained so as to obtain the position of the toothbrush, whether brushing is effective can be judged, and effective toothbrush time in each second classification area is counted so as to guide users to clean oral cavity space thoroughly.

KR20150113647 A (Rpboprint Co Ltd) relates to a camera built-in toothbrush and a tooth medical examination system using the same. A tooth state is photographed before and after brushing by using the camera built-in toothbrush, and the tooth state is displayed through a display unit and confirmed with a naked eye in real time. The photographed tooth image is transmitted to a remote medical support device in a hospital and the like, so a remote treatment can be performed.

In a research article published as Marcon M., Sarti A., Tubaro S. (2016) Smart Toothbrushes: Inertial Measurement Sensors Fusion with Visual Tracking. In: Hua G., Jegou H. (eds) Computer Vision—ECCV 2016 Workshops. ECCV 2016. Lecture Notes in Computer Science, vol 9914. Springer, Cham. hftps://doi.org/10.1007/978-3-319-48881-3_33, the authors have compared two previously known smart toothbrushes to find advantages and disadvantages and to cross-check their accuracy and reliability, with the aim to to assert how oral care for kids, adults and people with dental diseases can take great advantage from the next generation of smart toothbrushes.

It would be desirable to be able to track the motion of a toothbrush or other toothcare appliance in a user's mouth without requiring electronic sensors to be built in to, or applied to, the toothbrush itself. It would also be desirable to be able to track the motion of a toothbrush, relative to a user's mouth, using a relatively conventional video imaging system such as that found on a ubiquitous ‘smartphone’ or other widely available consumer device such as a computer tablet or the like. It would be desirable if the video imaging system to be used need not be a three-dimensional imaging system such as those using stereoscopic imaging. It would also be desirable to provide a toothbrush or other toothcare appliance tracking system which can provide a user with real-time feedback based on regions of the mouth that have been brushed or treated during a toothbrushing or toothcare session. The invention may achieve one or more of the above objectives.

### SUMMARY OF THE INVENTION

According to one aspect, the present invention provides a method of tracking a user's toothcare activity comprising:
receiving video images of a user's face during a toothcare session;
identifying, in each of a plurality of frames of the video images, predetermined features of the user's face, the features including at least two invariant landmarks associated with the user's face and one or more landmarks selected from at least mouth feature positions and eye feature positions;
identifying, in each of said plurality of frames of the video images, predetermined marker features of a toothcare appliance in use;
from the at least two invariant landmarks associated with the user's face, determining a measure of inter-landmark distance;
determining a toothcare appliance length normalised by the inter-landmark distance;
determining, from the one or more landmarks selected from at least mouth feature positions and eye feature positions, one or more appliance-to-facial feature distances each normalised by the inter-landmark distance;
determining an appliance-to-nose angle and one or more appliance-to-facial feature angles; using the determined angles, the normalised appliance length and the normalised appliance-to-facial feature distances, classifying each frame as corresponding to one of a plurality of possible tooth regions being treated with the toothcare appliance.

The toothcare activity may comprise toothbrushing. The toothcare appliance may comprise a toothbrush. The at least two invariant landmarks associated with the user's face may comprise landmarks on the user's nose. The inter-landmark distance may be a length of the user's nose.

The one or more appliance-to-facial feature distances each normalised by the nose length may comprise any one or more of:
(i) an appliance-to-mouth distance normalised by nose length;
(ii) an appliance-to-eye distance normalised by nose length;
(iii) an appliance-to-nose bridge distance normalised by nose length;
(iv) an appliance-to-left mouth corner distance normalised by nose length;
(v) an appliance-to-right mouth corner distance normalised by nose length;
(vi) an appliance-to-left eye distance normalised by nose length;
(vii) an appliance-to-right eye distance normalised by nose length;
(viii) an appliance-to-left eye corner distance normalised by nose length;
(ix) an appliance-to-right eye corner distance normalised by nose length.

The one or more appliance-to-facial feature angles may comprise any one or more of:
(i) an appliance-to-mouth angle;
(ii) an appliance-to-eye angle;
(iii) an angle between a vector going from an appliance marker to the nose bridge and a vector going from the nose bridge to the tip of the nose;
(iv) an angle between a vector going from an appliance marker to the left mouth corner and a vector going from the left mouth corner to the right mouth corner;
(v) an angle between a vector going from an appliance marker to the right mouth corner and a vector going from the left mouth corner to the right mouth corner;
(vi) an angle between a vector going from an appliance marker to the centre of the left eye and a vector going from the centre of the left eye to the centre of the right eye;
(vii) an angle between a vector going from an appliance marker to the centre of the right eye and a vector going from the centre of the left eye to the centre of the right eye.

The at least two landmarks associated with the user's nose may comprise the nose bridge and the nose tip. The features of the appliance may comprise a generally spherical marker attached to or forming part of the appliance. The spherical marker may have a plurality of coloured segments or quadrants disposed around a longitudinal axis. The segments or quadrants of the marker may be each separated by a band of contrasting colour. The generally spherical marker may be positioned at an end of the appliance with its longitudinal axis aligned with the longitudinal axis of the appliance. Identifying, in each of the plurality of frames of the video images, predetermined features of an appliance in use may comprise: determining a location of the generally spherical marker in the frame; cropping the frame to capture the marker; resizing the cropped frame to a predetermined pixel size; determining the pitch, roll and yaw angles of the marker using a trained orientation estimator; using the pitch, roll and yaw angles to determine an angular relationship between the appliance and the user's head. Identifying, in each of said plurality of frames of the video images, predetermined features of an appliance in use may comprise: identifying bounding box coordinates for each of a plurality of candidate appliance marker detections, each with a corresponding detection likelihood score; determining a spatial position of the appliance relative to the user's head based on coordinates of a bounding box having a detection likelihood score greater than a predetermined threshold and/or having the highest score. The method may further include disregarding frames where the bounding box coordinates are separated in space from at least one of said predetermined features of the user's face by greater than a threshold separation value. Candidate appliance marker detections may be determined by a trained convolutional neural network. Determining an appliance length may comprise determining a distance between the generally spherical marker and one or more landmarks associated with the user's mouth, the distance being normalised by the inter-landmark distance.

Classifying each frame as corresponding to one of a plurality of possible tooth regions being treated may further comprise using the determined angles, the normalised appliance length and the normalised appliance-to-facial feature distances, as well as one or more of:
(i) head pitch, roll and yaw angles;
(ii) mouth landmark coordinates;
(iii) eye landmark coordinates;
(iv) nose landmark coordinates;
(v) pitch, roll and yaw angle of the appliance derived from the appliance marker features;
(vi) appliance position coordinates;
(vii) appliance marker detection confidence scores;
(viii) appliance marker angle estimation confidence scores;
(ix) appliance angle sine and cosine values
as inputs to a trained classifier, the output of the trained classifier providing a tooth region therefrom.

Classifying each frame as corresponding to one of a plurality of possible tooth regions being treated may comprise using any of the following as trained classifier inputs:
(i) appliance marker pitch, roll and yaw angles;
(ii) appliance marker pitch, roll and yaw angles sine and cosine values;
(iii) appliance marker pitch, roll and yaw angles estimation confidence scores;
(iv) appliance marker detection confidence score;
(v) head pitch, roll and yaw angles;
(vi) appliance length, estimated as the distance between the appliance marker and mouth centre coordinates, normalised by nose length;
(vii) angle, as well as its sine and cosine, between two vectors: one going from the appliance marker to the nose bridge, the other going from the nose bridge to the tip of the nose (nose line);
(viii) length of the vector between the appliance marker and the nose bridge normalised by the nose length;
(ix) angle between two vectors: one going from the appliance marker to the left mouth corner, the other going from the left mouth corner to the right mouth corner (mouth line);
(x) length of the vector between the appliance marker and the left mouth corner normalised by the nose length;
(xi) angle between two vectors: one going from the appliance marker to the right mouth corner, the other going from the left mouth corner to the right mouth corner (mouth line);
(xii) length of the vector between the appliance marker and the right mouth corner normalised by the nose length;
(xiii) angle between two vectors: one going from the appliance marker to the centre of the left eye, the other one going from the centre of the left eye to the centre of the right eye (eye line);
(xiv) length of the vector between the appliance marker and the centre of the left eye normalised by the nose length;
(xv) angle between two vectors: one going from the appliance marker to the centre of the right eye, the other one going from the centre of the left eye to the centre of the right eye (eye line);
(xvi) length of the vector between the appliance marker and the centre of the right eye normalised by the nose length;
the output of the trained classifier providing a tooth region therefrom.

The tooth regions may comprise any of: Left Outer, Left Upper Crown Inner, Left Lower Crown Inner, Centre Outer, Centre Upper Inner, Centre Lower Inner, Right Outer, Right Upper Crown Inner, Right Lower Crown Inner.

According to another aspect, the present invention provides a toothcare appliance activity tracking apparatus comprising:
a processor configured to perform the steps as defined above.

The toothcare appliance activity tracking apparatus may further comprise a video camera for generating a plurality of frames of said video images. The toothcare appliance activity tracking apparatus may further comprise an output device configured to provide an indication of the classified tooth regions being treated during the toothcare activity.

The toothcare appliance activity tracking apparatus may be comprised within a smartphone.

According to another aspect, the invention provides a computer program, distributable by electronic data transmission, comprising computer program code means adapted, when said program is loaded onto a computer, to make the computer execute the procedure of any of the methods defined above, or a computer program product, comprising a computer readable medium having thereon computer program code means adapted, when said program is loaded onto a computer, to make the computer execute the procedure of any one of methods defined above.

According to another aspect, the invention provides a toothcare appliance comprising a generally spherical marker attached to or forming part of the appliance, the generally spherical marker having a plurality of coloured segments or quadrants disposed around a longitudinal axis defined by the toothcare appliance, the generally spherical marker including a flattened end to form a planar surface at an end of the appliance.

Each of the coloured segments may extends from one pole of the generally spherical marker to an opposite pole of the marker, the axis between the poles being in alignment with the longitudinal axis of the toothcare appliance. The segments or quadrants may be each separated from one another by a band of contrasting colour. The diameter of the generally spherical marker may lie between 25 mm and 35 mm and the widths of the bands may lie between 2 mm and 5 mm.

The toothcare appliance may comprise a toothbrush.

The flattened end of the generally spherical marker may define a planar surface of diameter between 86% and 98% of the full diameter of the sphere.

### BRIEF DESCRIPTION OF THE FIGURES

Embodiments of the present invention will now be described by way of example and with reference to the accompanying drawings in which:

FIG. 1 shows a schematic functional block diagram of the components of a toothbrush tracking system;

FIG. 2 shows a flow chart of a toothbrush tracking process implemented by the system of FIG. 1;

FIG. 3 shows a perspective view of a toothbrush marker structure suitable for tracking position and orientation of a toothbrush;

FIG. 4 shows a perspective view of the toothbrush marker of FIG. 3 mounted on a toothbrush handle.

### DETAILED DESCRIPTION OF THE FIGURES

The examples described hereinafter generally relate to toothbrushing activity, but the principles described may generally be extended to any other form of toothcare activity using a toothcare appliance. Such toothcare activities may, for example, encompass the application of tooth-whitening agent or application of a tooth or mouth medicament or material such as enamel serum, using any suitable form of toothcare appliance where tracking of surfaces of the teeth over which the toothcare appliance has travelled is required.

The expression ‘toothbrush’ used herein is intended to encompass both manual and electric toothbrushes.

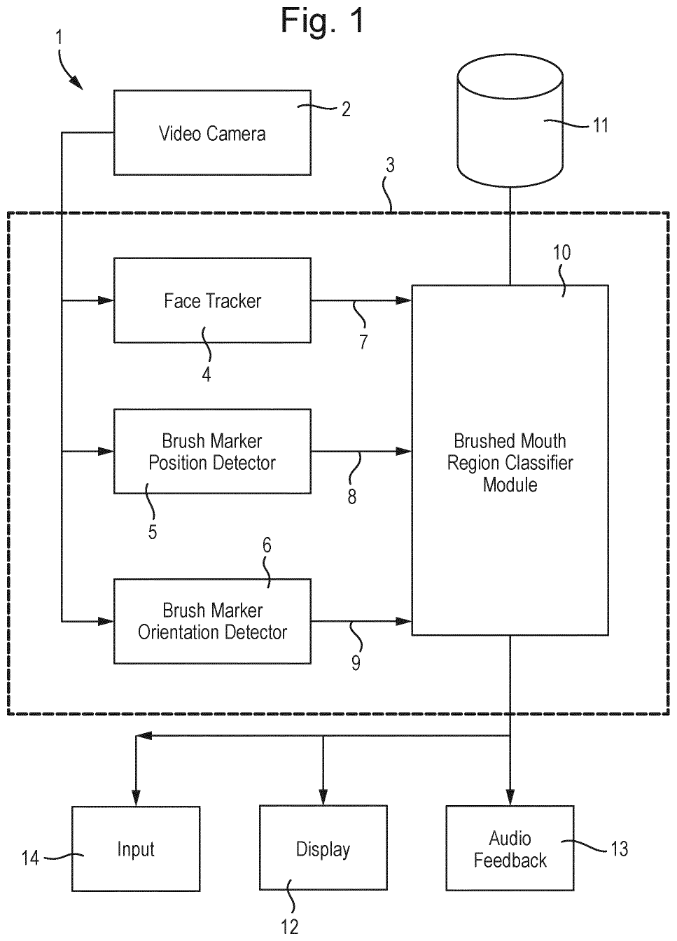

With reference to FIG. 1, a toothbrush motion tracking system 1 for tracking a user's toothbrushing activity may comprise a video camera 2. The expression ‘video camera’ is intended to encompass any image-capturing device that is suitable for obtaining a succession of images of a user deploying a toothbrush in a toothbrushing session. In one arrangement, the video camera may a camera as conventionally found within a smartphone or other computing device.

The video camera 2 is in communication with a data processing module 3. The data processing module 3 may, for example, be provided within a smartphone or other computing device, which may be suitably programmed or otherwise configured to implement the processing modules as described below. The data processing module 3 may include a face tracking module 4 configured to receive a succession of frames of the video and to determine various features or landmarks on a user's face and an orientation of the user's face therefrom. The data processing module 3 may further include a toothbrush marker position detecting module 5 configured to receive a succession of frames of the video and to determine a position of a toothbrush within each frame. The data processing module 3 may further include a toothbrush marker orientation estimating module 6 configured to receive a succession of frames of the video and to determine/estimate an orientation of the toothbrush within each frame. The expression ‘a succession of frames’ is intended to encompass a generally chronological sequence of frames, which may or may not constitute each and every frame captured by the video camera, and is intended to encompass periodically sampled frames and/or a succession of aggregated or averaged frames.

The respective outputs 7, 8, 9 of the face tracking module 4, the toothbrush marker position detecting module 5 and the toothbrush marker orientation detecting module 6 may be provided as inputs to a brushed mouth region classifier 10 which is configured to determine a region of the mouth that is being brushed. In one example, the classifier 10 is configured to be able to classify each video frame of a brushing action of the user as corresponding to brushing one of the following mouth regions/teeth surfaces: Left Outer, Left Upper Crown Inner, Left Lower Crown Inner, Centre Outer, Centre Upper Inner, Centre Lower Inner, Right Outer, Right Upper Crown Inner, Right Lower Crown Inner. This list of mouth regions/teeth surfaces is a currently preferred categorisation, but the classifier may be configured to classify brushing action into fewer or more mouth regions/teeth surfaces if desired and according to the resolution of the classifier training data.

A suitable storage device 11 may be provided for programs and toothbrushing data. The storage device 11 may comprise the internal memory of, for example, a smartphone or other computing device, and/or may comprise remote storage. A suitable display 12 may provide the user with, for example, visual feedback on the real-time progress of a toothbrushing session and/or reports on the efficacy of current and historical toothbrushing sessions. A further output device 13, such as a speaker, may provide the user with audio feedback. The audio feedback may include real-time spoken instructions on the ongoing conduct of a toothbrushing session, such as instructions on when to move to another mouth region or guidance on toothbrushing action. An input device 14 may be provided for the user to enter data or commands. The display 12, output device 13 and input device 14 may be provided, for example, by the integrated touchscreen and audio output of a smartphone.

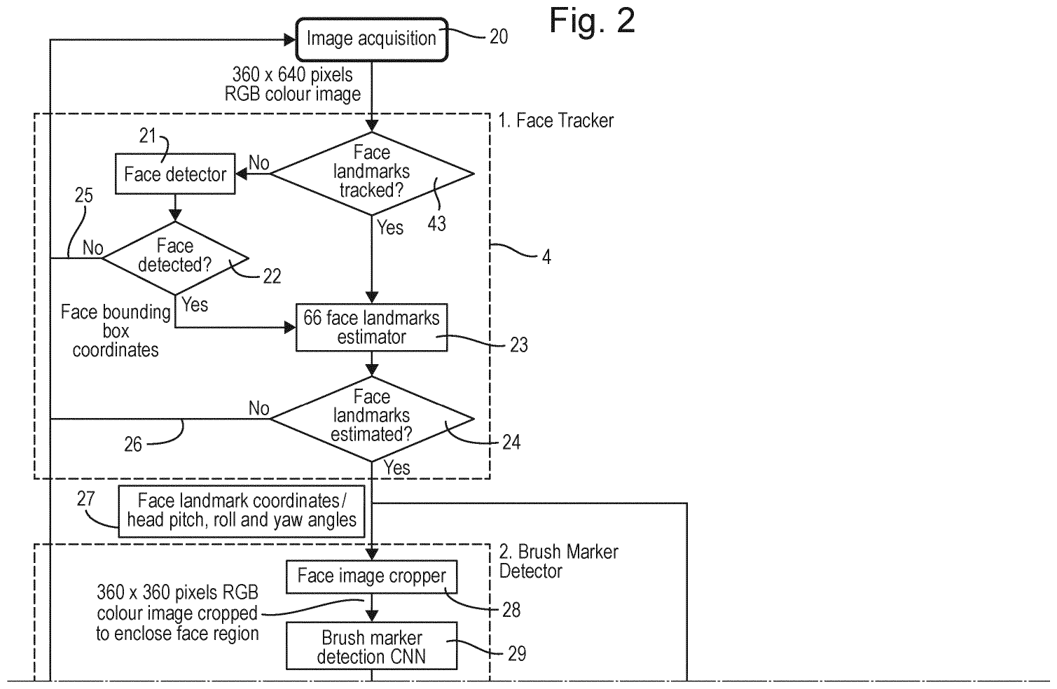

The functions of the various modules 4-6 and 10 above will now be described with reference to FIG. 2.

1. Face Tracking Module

The face tracking module 4 may receive (box 20) as input each successive frame or selected frames from the video camera 2. In one arrangement, the face tracking module 4 takes a 360×640-pixel RGB colour image, and attempts to detect the face therein (box 21). If a face is detected (box 22) the face tracking module 4 estimates the X-Y coordinates of a plurality of face landmarks therein (box 23). The resolution and type of image may be varied and selected according to requirements of the imaging processing.

In one example, up to 66 face landmarks may be detected, including edge or other features of the mouth, nose, eyes, cheeks, ears and chin. Preferably the landmarks include at least two landmarks associated with the user's nose, and preferably at least one or more landmarks selected from mouth feature positions (e.g. corners of the mouth, centre of the mouth) and eye feature positions (e.g. corners of the eyes, centres of the eyes). The face tracking module 4 also preferably uses the face landmarks to estimate some or all of head pitch, roll and yaw angles (box 27). The face tracking module 4 may deploy conventional face tracking techniques such as those described in E. Sanchez-Lozano et al. (2016). “Cascaded Regression with Sparsified Feature Covariance Matrix for Facial Landmark Detection”, Pattern Recognition Letters.

If the face tracking module 4 fails to detect a face (box 22), the module 4 may be configured to loop back (path 25) to obtain the next input frame and/or deliver an appropriate error message. If the face landmarks are not detected, or insufficient numbers of them are detected (box 24), the face tracking module may loop back (path 26) to acquire the next frame for processing and/or deliver an error message. Where face detection has been achieved in a previous frame, defining a search window for estimating landmarks, and the landmarks can be tracked (e.g. their positions accurately predicted) in a subsequent frame (box 43) then the face detection procedure (boxes 21, 22) may be omitted.

2. Brush Marker Position Detecting Module

The toothbrush used is provided with brush marker features that are recognizable by the brush marker position detecting module 5. The brush marker features may, for example, be well-defined shapes and/or colour patterns on a part of the toothbrush that will ordinarily remain exposed to view during a toothbrushing session. The brush marker features may form an integral part of the toothbrush, or may be applied to the toothbrush at a time of manufacture or by a user after purchase for example.

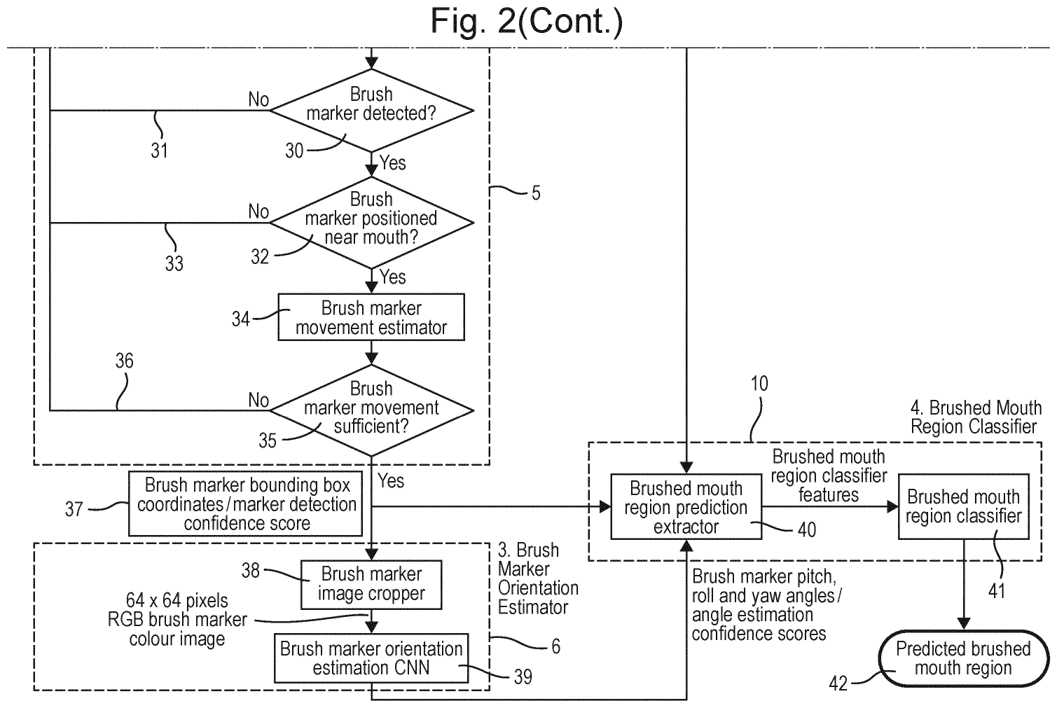

One particularly beneficial approach is to provide a structure at an end of the handle of the toothbrush, i.e. the opposite end to the bristles. The structure can form an integral part of the toothbrush handle or can be applied as an attachment or ‘dongle’ after manufacture. A form of structure found to be particularly successful is a generally spherical marker 60 (FIG. 3) having a plurality of coloured quadrants 61a, 61b, 61c, 61d disposed around a longitudinal axis (corresponding to the longitudinal axis of the toothbrush). In some arrangements as seen in FIG. 3, each of the quadrants 61a, 61b, 61c, 61d is separated from an adjacent quadrant by a band 62a, 62b, 62c, 62d of strongly contrasting colour. The generally spherical marker may have a flattened end 63 distal to the toothbrush-handle receiving end 64, the flattened end 63 defining a planar surface so that the toothbrush can be stood upright on the flattened end 63.

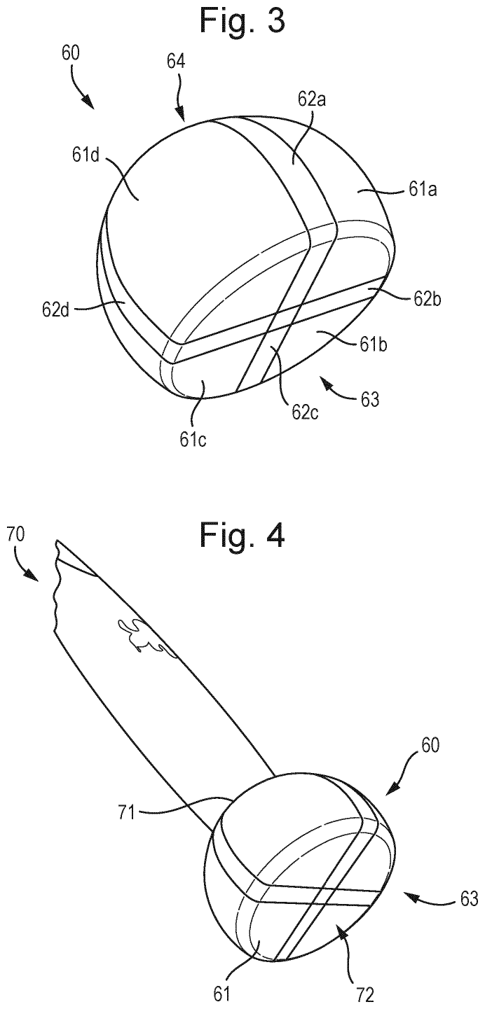

This combination of features may provide a number of advantages in that symmetrical features have been found to provide easier spatial location tracking whereas asymmetric features have been found to provide better location tracking. The different colours enhance the performance of the structure and are preferably chosen to have high colour saturation values for easy segmentation in poor and/or uneven lighting conditions. The choice of colours can be optimised for the particular model of video camera in use. As seen in FIG. 4, the marker 60 may be considered as having a first pole 71 attached to the end of a toothbrush handle 70 and a second pole 72 in the centre of the flattened end 63. The quadrants 61 may each provide a uniform colour or colour pattern that extends uninterrupted from the first pole 71 to the second pole 72, which colour or colour pattern strongly distinguishes from at least the adjacent quadrants, and preferably strongly distinguishes from all the other quadrants. In this arrangement, there may be no equatorial colour-change boundary between the poles. As also seen in FIG. 4, an axis of the marker extending between the first and second poles 71, 72 is preferably substantially in alignment with the axis of the toothbrush/toothbrush handle 70.

In one arrangement, the brush marker position detecting module 5 receives face position coordinates from the face tracking module 4 and crops (e.g. a 360×360-pixel) segment from the input image so that the face is positioned in the middle of the segment (box 28). The resulting image is then used by a convolutional neural network (box 29) in the brush marker detecting module 5, which returns a list of bounding box coordinates of candidate brush marker detections each accompanied with a detection score, e.g. ranging from 0 to 1.

The detection score indicates confidence that a particular bounding box encloses the brush marker. In one arrangement, the system may provide that the bounding box with the highest returned confidence corresponds with the correct position of the marker within the image provided that the detection confidence is higher than a pre-defined threshold (box 30). If the highest returned detection confidence is less than the pre-defined threshold, the system may determine that the brush marker is not visible. In this case, the system may skip the current frame and loop back to the next frame (path 31) and/or deliver an appropriate error message. In a general aspect, the brush marker position detecting module exemplifies a means for identifying, in each of a plurality of frames of the video images, predetermined marker features of a toothbrush in use from which a toothbrush position and orientation can be established.

If the brush marker is detected (box 30), the brush marker detecting module 5 checks the distance between the mouth landmarks and the brush marker coordinates (box 32). Should these be found too far apart from one another, the system may skip the current frame and loop back to the next frame (path 33) and/or return an appropriate error message. The brush-to-mouth distance tested in box 32 may be a distance normalised by nose length, as discussed further below.

The system may also keep track of the brush marker coordinates over time, estimating a marker movement value (box 34), for the purpose of detecting when someone is not brushing. If this value goes below pre-defined threshold (box 35), the brush marker detecting module 5 may skip the current frame, loop back to the next frame (path 36) and/or return an appropriate error message.

The brush marker detecting module 5 is preferably trained on a dataset composed of labelled real-life brush marker images in various orientations and lighting conditions taken from brushing videos collected for training purposes. Every image in the training dataset can be annotated with the brush marker coordinates in a semi-automatic way. The brush marker detector may be based on an existing pre-trained object detection convolutional neural network, which can be retrained to detect the brush marker. This can be achieved by tuning an object detection network using the brush marker dataset images, a technology known as transfer learning.

3. Brush Marker Orientation Estimator

The brush marker coordinates, or the brush marker bounding box coordinates (box 37), are passed to the brush orientation detecting module 6 which may crop the brush marker image and resize it (box 38) to a pixel count which may be optimised for the operation of a neural network in the brush marker orientation detecting module 6. In an example, the image is cropped/resized down to 64×64 pixels. The resulting brush marker image is then passed to a brush marker orientation estimator convolutional neural network (box 39), which returns a set of pitch, roll and yaw angles for the brush marker image. Similar to the brush marker position detection CNN, the brush marker orientation estimation CNN may also output a confidence level for every estimated angle ranging from 0 to 1.

The brush marker orientation estimation CNN may be trained on any suitable dataset of images of the marker under a wide range of possible orientation and background variations. Every image in the dataset may be accompanied by the corresponding marker pitch, roll and yaw angles.

4. Brushed mouth region classifier

The brushed mouth region classifier 10 accumulates the data generated by the three modules described above (face tracking module 4, brush marker position detecting module 5, and brush marker orientation detection module 6) to extract a set of features designed specifically for the task of mouth region classification to produce a prediction of mouth region (box 40).

The feature data for the classifier input is preferably composed of:
(i) face tracker data comprising one or more of face landmark coordinates and head pitch, roll and yaw angles;
(ii) brush marker detector data comprising one or more of brush marker coordinates and brush marker detection confidence score;
(iii) brush marker orientation estimator data comprising brush marker pitch, roll and yaw angles and brush marker angles confidence scores.

A significant number of the features used in mouth region classification may be derived either solely from the face tracker data or from a combination of the face tracker and the brush marker detector data. These features are designed to improve mouth region classification accuracy and to reduce the impact of unwanted variability in the input images, e.g. variability not relevant to mouth region classification, which otherwise might confuse the classifier and potentially lead to incorrect predictions. Examples of such variability include face dimensions, position and orientation.

In order to achieve this, the mouth region classifier may use the face tracker data in a number of the following ways:
(i) head pitch, roll and yaw angles enable the classifier to learn to differentiate among the mouth regions under a variety of head rotations in three-dimensional space with respect to the camera view;
(ii) mouth landmark coordinates are used to estimate projected (with respect to camera view) length of the brush, as a length of vector between the marker (the end of the brush) and the centre of the mouth;
(iii) mouth landmark coordinates are used to estimate the brush position with respect to the left and right mouth corners;
(iv) eyes landmark coordinates are used to estimate the brush position with respect to the centre of the left and right eyes;
(v) nose landmark coordinates are used to estimate the brush position with respect to the nose—these coordinates may also be used to compute projected nose length as a Euclidean distance between the nose bridge and the tip of the nose.

Projected nose length is used to normalise all mouth region classification features derived from distances.

Nose length normalisation of distance-derived features makes the mouth region classifier 10 less sensitive to variations in the distance between the person brushing and the camera, which affects projected face dimensions. It preferably works by measuring all distances in fractions of the person's nose length instead of absolute pixel values, thus reducing variability of the corresponding features caused by distance the person is from the camera.

Projected nose length, although being a variable itself due to anatomical and age aspects of every person, has been found to be a most stable measure of how far the person is from the camera and it is least affected by facial expressions. It is found to be relatively unaffected or invariant as the face is turned between left, centre and right facing orientations relative to the camera. This is in contrast to overall face height for instance, which might also be used for this purpose, but is prone to change due to variable chin position depending on how wide the person's mouth is open during brushing. Eye spacing might also be used, but this can be more susceptible to uncorrectable variation as the face turns from side to side and may also cause tracking failure when the eyes are closed. Thus, although any pair of facial landmarks that remain invariant in their relative positions may be used to generate a normalisation factor used to normalise the mouth region classification features derived from distances, it is found that the projected nose length achieves superior results. Thus, in a general aspect, any at least two invariant landmarks associated with the user's face may be used to determine an inter-landmark distance that is used to normalise the classification features derived from distances, with nose length being a preferred option.

An example set of features which enables an optimal brushed mouth region classification accuracy has been found to be composed of at least some or all of:
(i) brush marker pitch, roll and yaw angles;
(ii) brush marker pitch, roll and yaw angles sine and cosine values;
(iii) brush marker pitch, roll and yaw angles estimation confidence scores;
(iv) brush marker detection confidence score;
(v) head pitch, roll and yaw angles;
(vi) brush length, estimated as the distance between the brush marker and mouth centre coordinates, normalised by nose length;
(vii) angle, as well as its sine and cosine, between two vectors: one going from the brush marker to the nose bridge, the other going from the nose bridge to the tip of the nose (nose line);
(viii) length of the vector between the brush marker and the nose bridge normalised by the nose length;
(ix) angle between two vectors: one going from the brush marker to the left mouth corner, the other going from the left mouth corner to the right mouth corner (mouth line);
(x) length of the vector between the brush marker and the left mouth corner normalised by the nose length;
(xi) angle between two vectors: one going from the brush marker to the right mouth corner, the other going from the left mouth corner to the right mouth corner (mouth line);
(xii) length of the vector between the brush marker and the right mouth corner normalised by the nose length;
(xiii) angle between two vectors: one going from the brush marker to the centre of the left eye, the other one going from the centre of the left eye to the centre of the right eye (eye line);
(xiv) length of the vector between the brush marker and the centre of the left eye normalised by the nose length;
(xv) angle between two vectors: one going from the brush marker to the centre of the right eye, the other one going from the centre of the left eye to the centre of the right eye (eye line);
(xvi) length of the vector between the brush marker and the centre of the right eye normalised by the nose length.

Once extracted, some or preferably all the features listed in the set above are passed to a brushed mouth region Support Vector Machine (SVM) (box 41) in the brushed mouth region classifier 10, as classifier inputs. The classifier 10 outputs an index of the most probable mouth region that is currently being brushed, based on the current image frame or frame sequence.

Facial landmark coordinates (such as eyes, nose and mouth positions) and toothbrush coordinates are preferably not directly fed into the classifier 10, but used to compute various relative distances and angles of the brush with respect to the face, among other features as indicated above.

The brush length is a projected length, meaning that it changes as a function of the distance from the camera and the angle with respect to the camera. The head angles help the classifier take account of the variable angle, and the nose length normalisation of brush length helps accommodate the variability in projected brush length caused by the distance from the camera. Both of these means together help the classifier determine better the extent to which the brush is concealed within the mouth regardless of the camera angle/distance, which is directly correlated with which mouth region is brushed. It is found that a classifier trained on a specific brush or other appliance length works well for other appliances of similar length when a corresponding marker is attached thereto. A classifier trained on a manual toothbrush is also expected to operate accurately on an electric toothbrush of similar length with a corresponding marker attached thereto.

The mouth region classifier may be trained on a dataset of labelled videos capturing persons brushing their teeth. Every frame in the dataset is labelled by an action the frame depicts. These may include “IDLE” (no brushing), “MARKER NOT VISIBLE”, “OTHER” and the nine brushing actions each corresponding to a specific mouth region or teeth surface region. In a preferred example, these regions correspond to: Left Outer, Left Upper Crown Inner, Left Lower Crown Inner, Centre Outer, Centre Upper Inner, Centre Lower Inner, Right Outer, Right Upper Crown Inner, Right Lower Crown Inner.

A training dataset may be composed of two sets of videos. A first set of videos may be recorded from a single viewpoint with the camera mounted in front of the person at eye level height, capturing unrestricted brushing. A second set of videos may capture restricted brushing, where the participant is instructed which mouth region to brush, when and for how long. These videos may be recorded from multiple different viewpoints. In one example, four different viewpoints were used. Increasing the number and range of viewing positions may improve the classification accuracy.

The toothbrush tracking systems as exemplified above can enable purely visual-based tracking of a toothbrush and facial features to predict mouth region. No sensors need be placed on the brush (though the techniques described herein could be enhanced if such toothbrush sensor data were available). No sensors need be placed on the person brushing (though the techniques described herein could be enhanced if such on-person sensor data were available). The technique can be implemented robustly with sufficient performance on currently available mobile phone technologies. The technique can be performed using conventional 2D camera video images.

The systems described above offer superior performance of brushed mouth region prediction/detection by not only tracking where the brush is and its orientation, but also tracking the mouth location and orientation, relative to normalising properties of the face, thereby allowing the position of the brush to be directly related to the position of the mouth and head.

Throughout the present specification, the expression ‘module’ is intended to encompass a functional system which may comprise computer code being executed on a generic or a custom processor, or a hardware machine implementation of the function, e.g. on an application-specific integrated circuit.

Although the functions of, for example, the face tracking module 4, the brush marker position detecting module 5, the brush marker orientation estimator/detector module 6 and the brushed mouth region classifier 10 have been described as distinct modules, the functionality thereof could be combined within a suitable processor as single or multithread processes, or divided differently between different processors and/or processing threads. The functionality can be provided on a single processing device or on a distributed computing platform, e.g. with some processes being implemented on a remote server.

At least part of the functionality of the data processing system may be implemented by way of a smartphone application or other process executing on a mobile telecommunication device. Some or all of the described functionality may be provided on the smartphone. Some of the functionality may be provided by a remote server using the long range communication facilities of the smartphone such as the cellular telephone network and/or wireless internet connection.

It has been found that the techniques described above are particularly effective in reducing the influence of variable or unknown person-to-camera distance and variable or unknown person-to-camera angle, which can be difficult to assess using a 2D imaging device only. The set of features designed and selected for the brushed mouth region classifier 10 inputs preferably include head pitch, roll and yaw angles to account for the person's head orientation with respect to the camera and the nose length normalisation (or other normalisation distance between two invariant facial landmarks) accounts for the variable distance between the person and the camera.

The use of facial points improves mouth region classification by computing relative position of the brush marker with respect to these points, provided that the impact of variable person-to-camera distance is minimised by the nose length normalisation and the person-to-camera angle is accounted for by the head angles.

Modifications to the design of brush marker features as described in connection with FIGS. 3 and 4 are possible. For example, while the illustrated marker 60 is divided into four quadrants each extending from one pole of the generally spherical marker to the other pole of the marker, a different number of segments 61 could be used, provided that they are capable of enabling the orientation detecting module 6 to detect orientation with adequate resolution and precision, e.g. three, five or six segments disposed around the longitudinal axis. The bands 62 that separate the segments 61 can extend the full circumference of the brush marker, e.g. from pole to pole, or may extend only a portion of the circumference. The bands 62 may be of any suitable width to optimise recognition of the marker features and detection of the orientation by the orientation detection module. In preferred examples, the diameter of the marker 60 is between 25 and 35 mm (and in one specific example approximately 28 mm) and the widths of the bands 62 may lie between 2 mm and 5 mm (and in the specific example 3 mm).

The choice of contrasting colours for each of the segments may be made to optimally contrast with skin tones of a user using the toothbrush. In the example shown red, blue, yellow and green are used. The colours and colour region dimensions may also be optimised for the video camera 2 imaging device used, e.g. for smartphone imaging devices. The colour optimisation may take account of both the imaging sensor characteristics and the processing software characteristics and limitations. The optimisation of the size of the marker (e.g. as exemplified above) may also take into account a specific working distance range from the imaging device to the toothbrush marker 60, e.g. to ensure a minimum number of pixels can be captured for each colour block, particularly of the boundary stripes while ensuring that the marker size is not so great as to degrade the performance of the face tracking module 4 by excessive occlusion of facial features during tracking.

The flattened end 63 may be dimensioned to afford requisite stability of the toothbrush or other toothcare appliance when it is stood on the flattened end. In the example above, the flattened end may be that which results from removal of between 20% and 40% longitudinal dimension of the sphere. In the specific example above of a 28 mm diameter sphere, the plane section defined by the flattened end 63 is at approximately 7 to 8 mm along the longitudinal axis, i.e. shortening the longitudinal dimension of the sphere (between the poles) by approximately 7 to 8 mm. In other examples, the flattened end 63 may define a planar surface having a diameter in the range of 24 to 27.5 mm or a diameter of between 86% and 98% of the full diameter of the sphere, and in the specific example above, 26 mm or 93% of the full diameter of the sphere.

The expression “generally spherical” as used herein are intended to encompass a marker having a spherical major surface (or, e.g. one which defines an oblate spheroid) of which a portion within the ranges as described above is removed/not present in order to define a minor planar surface thereon.

Results using the marker 60 as depicted in FIGS. 3 and 4, i.e. with a flattened end 63 and with contrasting colours for adjacent segments/quadrants 61 and the separation bands 62 between segments/quadrants 61 have been compared with a spherical marker with more limited colour changes and show a significant improvement in orientation estimation results and classification accuracy, as shown in table 1 below:

TABLE 1

| | |
|---|---|
| Z orientation | X orientation |

| Error | | FIG. 3/4 | | FIG. 3/4 |
|---|---|---|---|---|
| threshold | Spherical | example | Spherical | example |
| <5° | 13.4% | 28.4% | 27.3% | 57.5% |
| <10° | 26.5% | 51.5% | 32.8% | 82.0% |
| <20° | 50.0% | 77.4% | 58.7% | 90.1% |
| <30° | 66.1% | 86.0% | 74.2% | 92.1% |

where the Z orientation data shows the number of samples achieving the angular measurement error threshold of the left hand column about the Z-axis (corresponding to the axis extending between the first and second poles of the marker, and therefore the long axis of the toothbrush) while the X orientation data shows the number of samples achieving the angular measurement error threshold of the left hand column about the X-axis (corresponding to one of the axes extending orthogonally to the Z/longitudinal axis of the marker/toothbrush). It will be understood that the Y orientation accuracy data will generally correspond to the X axis accuracy data. These levels of accuracy have been found adequate to achieve the classification of mouth regions and teeth surfaces as exemplified above.

Other embodiments are intentionally within the scope of the accompanying claims.

1.-28. (canceled)

29. A method of tracking a user's toothcare activity comprising:
receiving video images of a user's face during a toothcare session;
identifying, in each of a plurality of frames of the video images, predetermined features of the user's face, the features including at least two invariant landmarks associated with the user's face and one or more landmarks selected from at least mouth feature positions and eye feature positions, wherein the at least two invariant landmarks are invariant in position relative to each other; and
identifying, in each of said plurality of frames of the video images, predetermined marker features of a toothcare appliance in use by the user, in which the features of the appliance comprise a generally spherical marker attached to or forming part of the appliance, the spherical marker having a plurality of coloured segments or quadrants disposed around a longitudinal axis;
wherein from the at least two invariant landmarks associated with the user's face,
determining a measure of inter-landmark distance;
determining a toothcare appliance length, wherein determining the appliance length comprises determining a distance between the generally spherical marker and one or more landmarks associated with the user's mouth, the distance being normalised by the inter-landmark distance;
determining, from the one or more landmarks selected from at least mouth feature positions and eye feature positions, one or more appliance-to-facial feature distances each normalised by the inter-landmark distance;
determining an appliance-to-nose angle and one or more appliance-to-facial feature angles; and
using the determined angles, the normalised appliance length and the normalised appliance-to-facial feature distances, classifying each frame as corresponding to one of a plurality of possible tooth regions being treated with the toothcare appliance.

30. The method of claim 29, wherein the toothcare activity comprises toothbrushing and the toothcare appliance comprises a toothbrush.

31. The method of claim 29, wherein the at least two invariant landmarks associated with the user's face comprise landmarks on the user's nose.

32. The method of claim 31, wherein the inter-landmark distance is a length of the user's nose.

33. The method of claim 32, wherein the one or more appliance-to-facial feature distances each normalised by the nose length comprise one or more of:
(i) an appliance-to-mouth distance normalised by nose length;
(ii) an appliance-to-eye distance normalised by nose length;
(iii) an appliance-to-nose bridge distance normalised by nose length;
(iv) an appliance-to-left mouth corner distance normalised by nose length;
(v) an appliance-to-right mouth corner distance normalised by nose length;
(vi) an appliance-to-left eye distance normalised by nose length;
(vii) an appliance-to-right eye distance normalised by nose length;
(viii) an appliance-to-left eye corner distance normalised by nose length;
(ix) an appliance-to-right eye corner distance normalised by nose length.

34. The method of claim 32, wherein the one or more appliance-to-facial feature angles comprise one or more of:
(i) an appliance-to-mouth angle;
(ii) an appliance-to-eye angle;
(iii) an angle between a vector going from an appliance marker to the nose bridge and a vector going from the nose bridge to the tip of the nose;
(iv) an angle between a vector going from an appliance marker to the left mouth corner and a vector going from the left mouth corner to the right mouth corner;
(v) an angle between a vector going from an appliance marker to the right mouth corner and a vector going from the left mouth corner to the right mouth corner;
(vi) an angle between a vector going from an appliance marker to the centre of the left eye and a vector going from the centre of the left eye to the centre of the right eye;
(vii) an angle between a vector going from an appliance marker to the centre of the right eye and a vector going from the centre of the left eye to the centre of the right eye.

35. The method of claim 31, wherein the at least two landmarks associated with the user's nose comprise the nose bridge and the nose tip.

36. The method of claim 29, wherein the segments or quadrants are each separated by a band of contrasting colour.

37. The method of claim 29, wherein the generally spherical marker is positioned at an end of the appliance with its longitudinal axis aligned with the longitudinal axis of the appliance.

38. The method of claim 29, wherein identifying, in each of said plurality of frames of the video images, predetermined features of the appliance in use comprises:
determining a location of the generally spherical marker in the frame;
cropping the frame to capture the marker;
resizing the cropped frame to a predetermined pixel size;
determining the pitch, roll and yaw angles of the marker using a trained orientation estimator; and
using the pitch, roll and yaw angles to determine an angular relationship between the appliance and the user's head.

39. The method of claim 29, wherein identifying, in each of said plurality of frames of the video images, predetermined features of the appliance in use comprises:
identifying bounding box coordinates for each of a plurality of candidate appliance marker detections, each with a corresponding detection likelihood score; and
determining a spatial position of the appliance relative to the user's head based on coordinates of a bounding box having a detection likelihood score greater than a predetermined threshold and/or having the highest score.

40. The method of claim 29, wherein the generally spherical marker includes a flattened end to form a planar surface at the end of the appliance.

41. The method of claim 40, wherein the flattened end of the generally spherical marker defines a planar surface of diameter between 86% and 98% of the full diameter of the sphere.

42. A toothcare appliance activity tracking apparatus comprising:
a processor configured to perform the steps of claim 29.

43. A computer program, distributable by electronic data transmission, comprising computer program code means adapted, when said program is loaded onto a computer, to make the computer execute the procedure of claim 29 or a computer program product, comprising a computer readable medium having thereon computer program code means adapted, when said program is loaded onto a computer, to make the computer execute the procedure of claim 29.
